(19) United States
(12) Patent Application Publication
(10) Pub. No.: US 2015/0213425 A1
(43) Pub. Date: Jul. 30, 2015

(54) COMMODITY DATA REGISTRATION APPARATUS, CHECKOUT SYSTEM AND CHECKOUT DATA TRANSMISSION METHOD

(71) Applicant: TOSHIBA TEC KABUSHIKI KAISHA, Tokyo (JP)

(72) Inventors: Shinya Namura, Mishima (JP); Nobuhiro Sugita, Mishima (JP); Takayuki Kawahara, Mishima (JP)

(21) Appl. No.: 14/609,505

(22) Filed: Jan. 30, 2015

(30) Foreign Application Priority Data
Jan. 30, 2014 (JP) 2014-015937

(51) Int. Cl. G06Q 20/20

(52) U.S. Cl. CPC G06Q 20/202

(57) ABSTRACT

In accordance with one embodiment, a commodity data registration apparatus comprises a communication control module configured to control communication with a checkout apparatus connected through a network, an information input module configured to input identification information for identifying various commodities, a specification module configured to specify a commodity based on the identification information upon input of the identification information, a registration module configured to register sales data of the specified commodity indicating the content of one transaction of the commodity, a calculation module configured to calculate a total amount of the one transaction based on the registered sales data if the closing of the one transaction is declared, and a sending module configured to send a checkout data including the registered sales data and the calculated total amount to the checkout apparatus through the communication control module.

### CROSS-REFERENCE TO RELATED APPLICATION

This application is based upon and claims the benefit of priority from Japanese Patent Application No. 2014-015937, filed Jan. 30, 2014, the entire contents of which are incorporated herein by reference.

### FIELD

Embodiments described herein relate generally to a commodity data registration apparatus, a checkout system using the commodity data registration apparatus and a method for executing transmission of a checkout data by the commodity data registration apparatus.

### BACKGROUND

Conventionally, there has been proposed a checkout system consisting of a commodity data registration apparatus which reads out a unit price and other information relating to a commodity according to a commodity code input through a reader and the like to generate transaction data of the commodity and a checkout apparatus through which a customer executes a checkout processing based on the transaction data generated by the commodity data registration apparatus. Such a checkout system enables a shop clerk (checker) to save an operation time relating to the checkout job.

In accordance with such a checkout system described above, processing of the transaction data is halted and the transaction data is temporarily stored in the commodity data registration apparatus before the checkout processing is carried out by the checkout apparatus. The customer receives a receipt on which identification data for identifying the transaction data temporarily stored in the commodity data registration apparatus is printed. Then, the customer inputs through a reader or an input device the identification data printed on the receipt in the checkout apparatus to transmit the transaction data temporarily stored in the commodity data registration apparatus to the checkout apparatus to carry out checkout processing by the checkout apparatus.

However, in the conventional checkout system, a receipt on which the identification data is printed must be issued at the time the processing of the transaction data is halted, which leads to an increase in cost of receipt paper. In addition, the customer has to input the identification data printed on the receipt in the checkout apparatus through the reader, which takes time and labor.

### BRIEF DESCRIPTION OF THE DRAWINGS

FIG. 1 is a schematic view illustrating the whole checkout system according to one embodiment;

FIG. 2 is a perspective view illustrating the appearance of a commodity data registration apparatus;

FIG. 3 is a perspective view illustrating the appearance of a checkout apparatus;

FIG. 4 is a block diagram illustrating the hardware constitutions of the commodity data registration apparatus and the checkout apparatus;

FIG. 5 is a block diagram illustrating functional components of the commodity data registration apparatus and the checkout apparatus;

FIG. 6 is a flowchart illustrating a commodity sales registration processing carried out by the commodity data registration apparatus;

FIG. 7 is a front view illustrating an example of a registration screen;

FIG. 8 is a front view illustrating an example of a transmission destination selection screen;

FIG. 9 is a front view illustrating an example of a notification screen; and

FIG. 10 is a flowchart illustrating a checkout processing carried out by the checkout apparatus.

### DETAILED DESCRIPTION

In accordance with one embodiment, a commodity data registration apparatus comprises a communication control module configured to control communication with a checkout apparatus connected through a network, an information input module configured to input identification information for identifying various commodities, a specification module configured to specify a commodity based on the identification information upon input of the identification information, a registration module configured to register sales data of the specified commodity indicating the content of one transaction of the commodity, a calculation module configured to calculate a total amount of the one transaction based on the registered sales data if the closing of the one transaction is declared, and a sending module configured to send a checkout data including the registered sales data and the calculated total amount to the checkout apparatus through the communication control module.

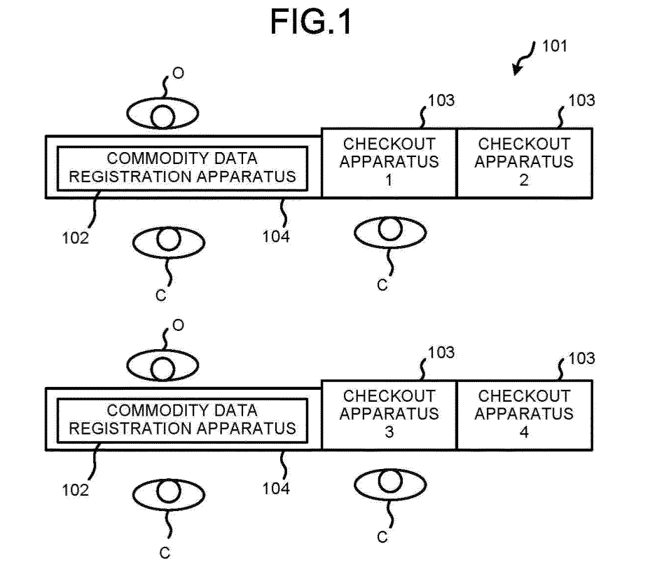

FIG. 1 is a schematic view illustrating the whole checkout system 101 according to the present embodiment. As shown in FIG. 1, the checkout system 101 includes a commodity data registration apparatus 102 operated by a checker O (shop clerk) and a checkout apparatus 103 operated by a customer C. The commodity data registration apparatus 102 is arranged on a horizontally extended work table 104.

In the present embodiment, two checkout apparatuses 103 are arranged for one commodity data registration apparatus 102. The checkout apparatuses 103 are arranged linearly adjacent to the worktable 104. Thus, a customer passage is formed between work tables 104.

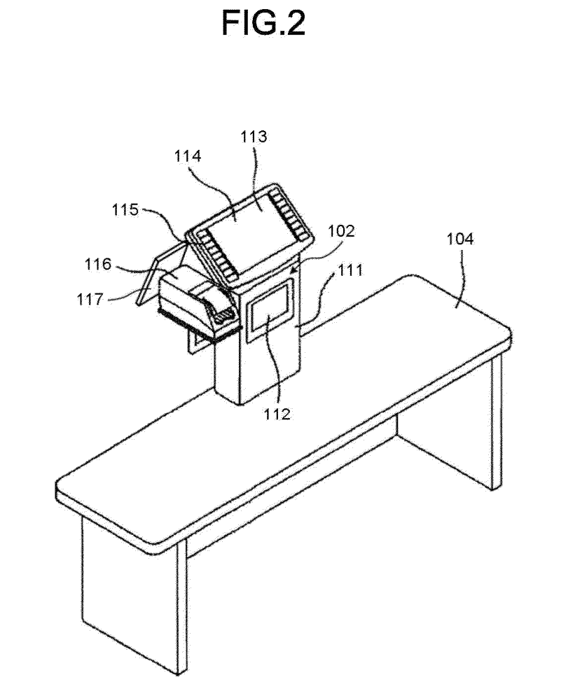

First, the commodity data registration apparatus 102 is described. FIG. 2 is a perspective view illustrating the appearance of the commodity data registration apparatus 102. As shown in FIG. 2, the commodity data registration apparatus 102 arranged on the work table 104 is basically equipped with a vertical scanner 111 having a reading window 112. The scanner 111 includes an image capturing section (not shown) arranged at the rear side of the reading window 112.

The commodity data registration apparatus 102 further includes a display device 114 with a touch panel 113 and a keyboard 115 arranged at the upper portion of the scanner 111. The display device 114 displays a commodity name, a price and the like of a commodity photographed by the image capturing section of the scanner 111. The touch panel 113 and the keyboard 115 are respectively used to assist input of commodity data.

A printer 116 is arranged at the left side of the commodity data registration apparatus 102. The printer 116 issues a receipt on which an identification data described later and a transaction data such as total amount of one transaction are printed.

A display for customer 117 for displaying information to the customer C is also arranged at the left side of the commodity data registration apparatus 102. The screen of the display for customer 117 is oriented to the customer C.

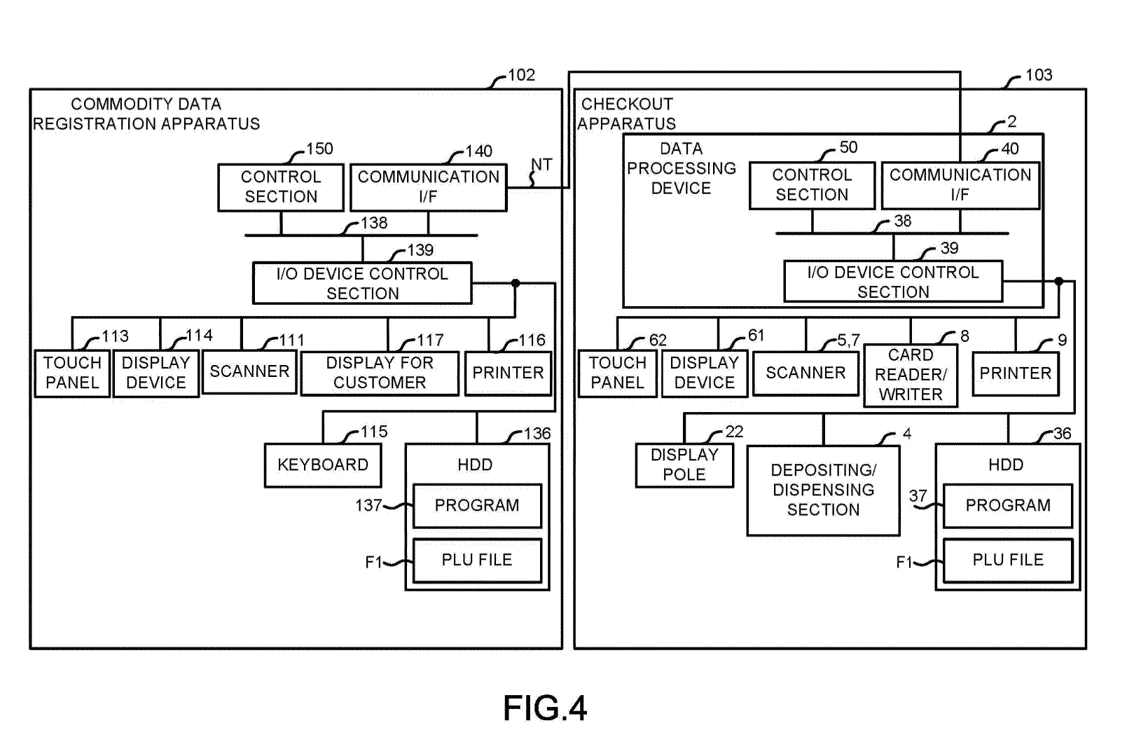

In the commodity data registration apparatus 102, a commodity contained in the image captured by the image capturing section is specified with reference to a PLU (Price Lookup table) File F1 (refer to FIG. 4) through a general object recognition or by reading code symbol such as a barcode or a QR code (registered trademark) attached to the commodity.

As to the general object recognition for recognizing an object contained in an image, various recognition technologies are described in the following document.

Keiji Yanai “Present situation and future of generic object recognition”, Journal of Information Processing Society, Vol. 48, No. SIG16 [Search on Heisei 26 January 6], Internet <URL: http://mm.cs.uec.ac.jp/IPSJ-TCVIM-Yanai.pdf>

Next, the commodity data registration apparatus 102 displays a screen for receiving an input of the confirmation of the specified commodity and the quantity thereof purchased on the display device 114. The commodity data registration apparatus 102 stores, based on the commodity code of the commodity of which the confirmation input is received and information such as the input quantity of commodity purchased and the like, information relating to sales registration, such as a commodity category, commodity name, unit price and the like, of the commodity corresponding to the commodity code in a sales master file (not shown) as a sales data or a checkout data to carry out a sales registration.

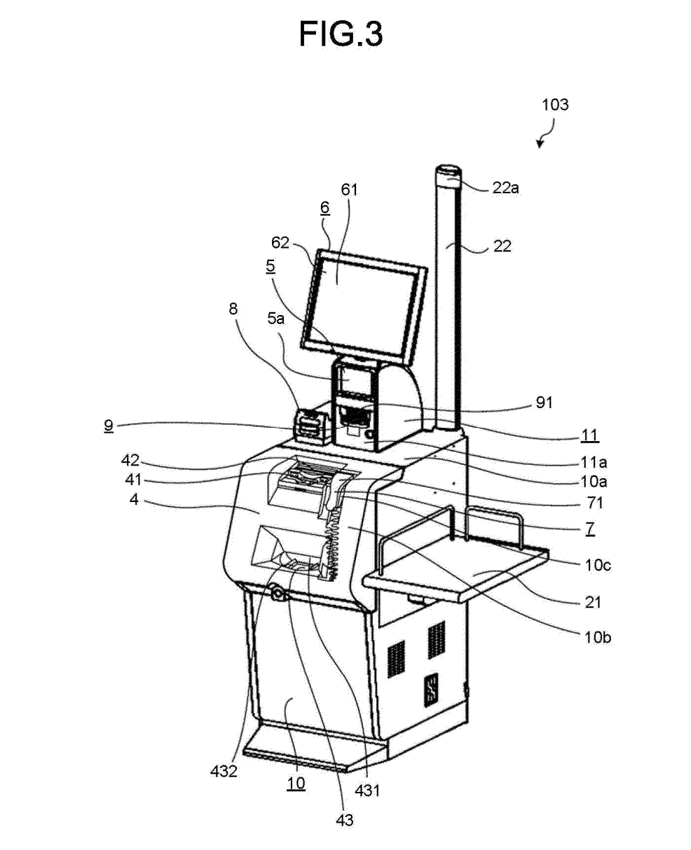

Next, the checkout apparatus 103 is described. FIG. 3 is a perspective view illustrating the appearance of the checkout apparatus 103. The checkout apparatus 103 according to the present embodiment can also function as a self-checkout POS (Point Of Sales) terminal, through which the customer C can carry out a commodity registration and a checkout processing, while no operator uses the checkout apparatus 103.

The checkout apparatus 103 includes a data processing device 2 (refer to FIG. 4), a depositing/dispensing section 4, a stationary scanner 5, a display operation panel 6, a handy scanner 7, a card reader/writer 8, a receipt printer 9, a first casing 10 and a second casing 11. The first casing 10, in which the data processing device 2 and the depositing/dispensing section 4 are arranged, is placed on the floor. The second casing 11 serving as a housing of the stationary scanner 5 and the receipt printer 9 is placed on an upper surface 10a of the first casing 10.

The stationary scanner 5 includes an image capturing window 5a arranged at the upper portion of the second casing 11 and an image capturing section (not shown) arranged inside the second casing 11. The image capturing section photographs a code symbol such as a barcode and the like held in front of the image capturing window 5a to capture the image of the code symbol and decodes the captured code symbol. The image capturing section outputs the decoded code data to the data processing device 2. In a case of carrying out a general object recognition, the image capturing section outputs a commodity image captured by photographing the commodity held in front of the image capturing window 5a to the data processing device 2.

The handy scanner 7 is movably arranged at the upper portion of a front side 10b of the first casing 10. A holding section 10c for holding the handy scanner 7 by hooking a front end part 71 of the handy scanner 7 is arranged at the upper right portion of the front side 10b of the first casing 10.

The display operation panel 6 including a display device 61 and a touch panel 62 is mounted on the second casing 11. The display device 61 displays an image under the control of the data processing device 2. The touch panel 62 arranged on the surface of the display device 61 outputs information based on a position touched by the operator to the data processing device 2.

The card reader/writer 8 is arranged adjacent to the second casing 11 on the upper surface 10a of the first casing 10. The card reader/writer 8 executes read/write operation of information from or to a magnetic card (data recording medium) such as a point card, a credit card and the like.

The depositing/dispensing section 4 includes a cash depositing port 41, a bill dispensing port 42 and a coin dispensing section 43. The coin dispensing section 43 includes a dispensing port 431 and a coin tray 432. The depositing/dispensing section 4 receives bills and coins deposited through the cash depositing port 41, and stores the bills and the coins separately. The depositing/dispensing section 4 dispenses change through the dispensing port 431 in response to a request of the data processing device 2. The dispensed change is received by the coin tray 432.

The receipt printer 9 includes a well-known printing section (not shown) arranged inside the second casing 11 and a receipt issuing port 91 arranged at the front side 11a of the second casing 11. The receipt printer 9 issues a receipt printed by the printing section from the receipt issuing port 91 under the control of the data processing device 2.

The data processing device 2 arranged inside the first casing 10 collectively controls each section (the depositing/dispensing section 4, the stationary scanner 5, the display operation panel 6, the handy scanner 7, the card reader/writer 8 and the receipt printer 9) of the checkout apparatus 103. The data processing device 2 acquires code information or a commodity image from the stationary scanner 5 or the handy scanner 7. The data processing device 2 outputs information to be displayed on the display device 61 of the display operation panel 6, and acquires information of an operation carried out by the operator through the touch panel 62. The data processing device 2 grasps the amount of cash deposited from the depositing/dispensing section 4 and instructs a dispensing of cash to the depositing/dispensing section 4.

The checkout apparatus 103 includes a basket placing table 21 arranged at one of the sides of the first casing 10. The basket placing table 21 is used for placing a shopping basket when the customer carries out the checkout processing.

The checkout apparatus 103 is further equipped with a display pole 22 which is vertically mounted on the first casing 10 and serves as a notification section for displaying the current operation status of the checkout apparatus 103. The display pole 22 includes a light emitting section 22a, which selectively emits blue and red light, at the top end part thereof.

Next, the hardware constitutions of the commodity data registration apparatus 102 and the checkout apparatus 103 are described. FIG. 4 is a block diagram illustrating the hardware constitutions of the commodity data registration apparatus 102 and the checkout apparatus 103.

As shown in FIG. 4, the commodity data registration apparatus 102 includes a control section 150 constituted with a computer consisting of, for example, a CPU (Central Processing Unit), a ROM (Read Only Memory) and a RAM (Random Access Memory) (none is shown) serving as a storage media. The ROM stores various programs executed by the CPU and various data. The RAM stores not only programs and data temporarily when the CPU executes various programs, but also sales data indicating commodity sales records and various screen display data displayed on the display device 114.

The control section 150 controls I/O devices such as the scanner 111, the touch panel 113, the display device 114, the keyboard 115, the printer 116, the display for customer 117 and an HDD (Hard Disk Drive) 136 through an I/O (Input/Output) device control section 139 and a bus line 138 to control the whole system of the commodity data registration apparatus 102.

The HDD 136, i.e., storage module, stores a PLU file F1 and a program 137 executable by the CPU of the control section 150. The PLU file F1 stores a commodity code uniquely assigned to each commodity in association with information relating to the commodity such as the name, price, commodity category and the like of the commodity. In a case of specifying a commodity through the general object recognition, the PLU file F1 also stores feature amount such as a hue, surface concave-convex state extracted from the commodity image.

The program 137 for operating the CPU of the control section 150 of the commodity data registration apparatus 102 is recorded in a computer-readable recording medium such as a CD-ROM, flexible disk (FD), CD-R, DVD (Digital Versatile Disk) and the like in the form of installable or executable file to be provided.

Further, the program 137 may be stored in a computer connected with a network such as Internet, and downloaded via the network. Alternatively, the program 137 may also be provided or distributed via a network such as Internet.

The control section 150 can communicate, through a communication I/F 140, with the checkout apparatus 103 and a store server (not shown) connected through a network NT such as a LAN (Local Area Network).

The store server generally carries out management on the commodity sales registration processing carried out by the one or a plurality of commodity data registration apparatuses 102 and the checkout processing carried out by the checkout apparatus 103 and the like arranged in the store.

On the other hand, as shown in FIG. 4, the checkout apparatus 103 includes a control section 50 constituted with a computer consisting of, for example, a CPU, a ROM and a RAM (none is shown) serving as a storage media in the data processing device 2. The ROM stores various programs executed by the CPU and various data. The RAM stores not only programs and data temporarily when the CPU executes various programs, but also sales data indicating commodity sales records and various screen display data displayed on the display device 61.

The control section 50 controls I/O devices such as the touch panel 62, the display device 61, the stationary scanner 5, the handy scanner 7, the card reader/writer 8, the receipt printer 9, the depositing/dispensing section 4, the display pole 22 and an HDD 36 through an I/O device control section 39 and a bus line 38 to control the whole system of the checkout apparatus 103.

The card reader/writer 8 reads information of the point card and credit card of the customer inserted into a card insertion port. The receipt printer 9 prints a receipt after the checkout processing is completed to issue it from the receipt issuing port 91. The depositing/dispensing section 4 processes the bills and the coins deposited from the cash depositing port 41. The depositing/dispensing section 4 dispenses change from the dispensing port 431 in response to a request.

The HDD 36, i.e., storage module, stores a PLU file F1 and a program 37 executable by the control section 50.

The program 37 for operating the CPU of the control section of the checkout apparatus 103 is recorded in a computer-readable recording medium such as a CD-ROM, flexible disk (FD), CD-R, DVD (Digital Versatile Disk) and the like in the form of installable or executable file to be provided.

Further, the program 37 may be stored in a computer connected with a network such as an Internet, and downloaded via the network. Alternatively, the program 37 may also be provided or distributed via a network such as the Internet.

The control section 50 can communicate, through a communication I/F 40, with the commodity data registration apparatus 102 and a store server (not shown) connected through a network NT such as a LAN.

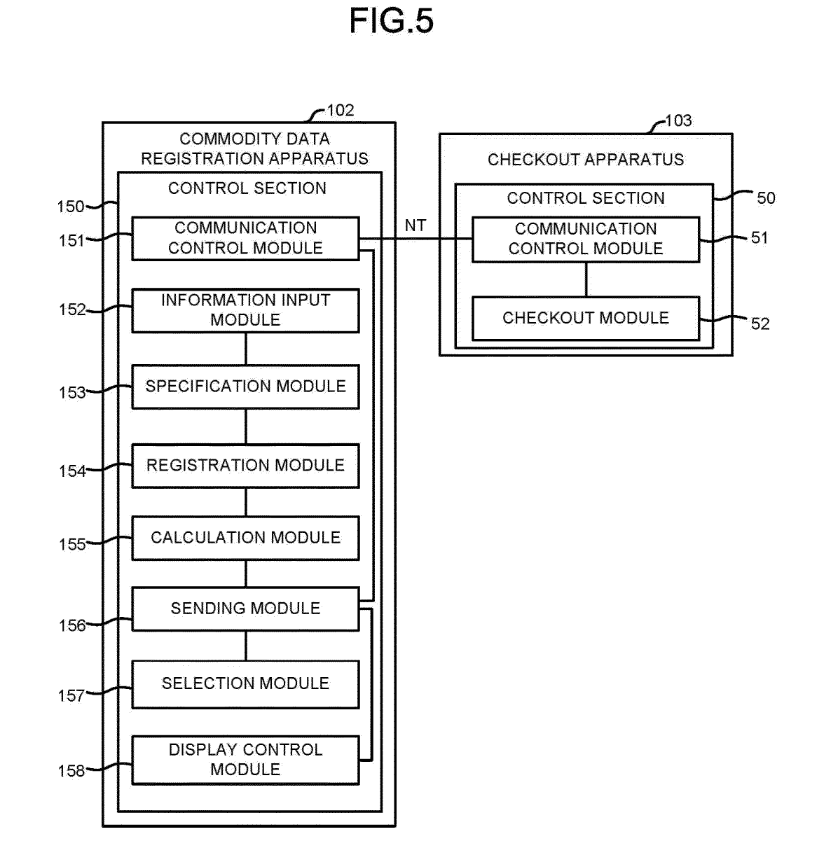

Next, the functional components realized by the CPU of the control section 150 of the commodity data registration apparatus 102 which executes the program 137, and the functional components realized by the CPU of the control section 50 of the checkout apparatus 103 which executes the program 37 are described with reference to FIG. 5.

FIG. 5 is a block diagram illustrating functional components of the commodity data registration apparatus 102 and the checkout apparatus 103. As shown in FIG. 5, the control section 150 of the commodity data registration apparatus 102 executes the program 137 stored in the HDD 136 to realize functions of a communication control module 151, an information input module 152, a specification module 153, a registration module 154, a calculation module 155, a sending module 156, a selection module 157 and a display control module 158.

Similarly, the control section 50 of the checkout apparatus 103 executes the program 37 stored in the HDD 36 to realize functions of a communication control module 51 and a checkout module 52.

The communication control module 151 controls, through the communication I/F 140, the communication with the checkout apparatus 103 connected through the network NT such as a LAN.

The information input module 152 inputs identification information for identifying various commodities. More specifically, the information input module 152 inputs the code information or the commodity image output from the scanner 111 as the identification information.

When the identification information is input, the specification module 153 specifies the commodity based on the identification information. More specifically, in a case in which the code information is input from the scanner 111, the specification module 153 specifies the commodity corresponding to the commodity code with reference to the PLU file F1. In a case in which the commodity image is input from the scanner 111, the specification module 153 specifies the commodity through the general object recognition for recognizing the object contained in the image.

The registration module 154 registers sales data of the specified commodity indicating the content relating to the commodity transaction. More specifically, the registration module 154 acquires information relating to the sales registration such as the commodity category, commodity name, unit price and the like of the commodity corresponding to the commodity code based on the information such as the input quantity and the commodity code of the specified commodity from the PLU file F1 as the sales data.

If there is an input of a closing operation (for example, the pressing operation of a subtotal key (not shown)) from the touch panel 113 or the keyboard 115 and the closing of the commodity transaction is declared, the calculation module 155 calculates a total amount in one transaction based on the registered sales data.

The sending module 156 sends the registered sales data and the calculated total amount (checkout data) to the checkout apparatus 103 through the communication control module 151.

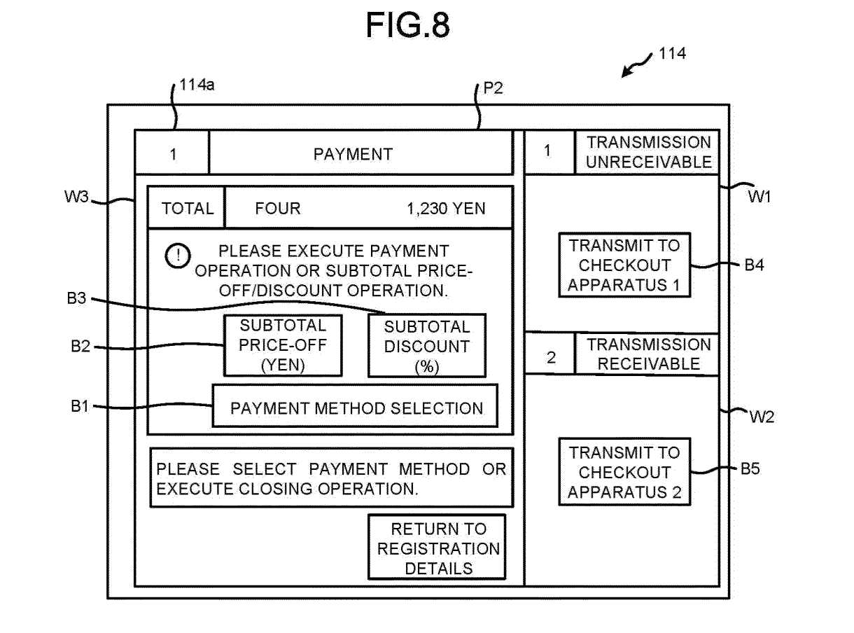

In a case in which there is more than one checkout apparatus 103 connected through the network, the selection module 157 selects one of the checkout apparatuses 103. Thus, the sending module 156 sends the registered sales data and the calculated total amount to the checkout apparatus 103 selected by the selection module 157. Such a selection module 157 displays a transmission destination selection screen P2 (refer to FIG. 8) for receiving a selection of the checkout apparatus 103 (transmission destination) on the display device 114, and receives the selection of one of the checkout apparatuses 103 in response to a touch-operation on the selection screen.

The display control module 158 displays the total amount and information indicating the checkout apparatus 103 (transmission destination) on the display device 114 and the display for customer 117 at the time the sending process is carried out by the sending module 156.

Further, the communication control module 51 controls, through the communication I/F 40, the communication with the commodity data registration apparatus 102 connected through the network NT such as a LAN.

The checkout module 52 executes a checkout processing based on the sales data (checkout data) of the specified commodity indicating the content relating to the commodity transaction and the total amount in one transaction calculated based on the sales data, which are sent from the commodity data registration apparatus 102.

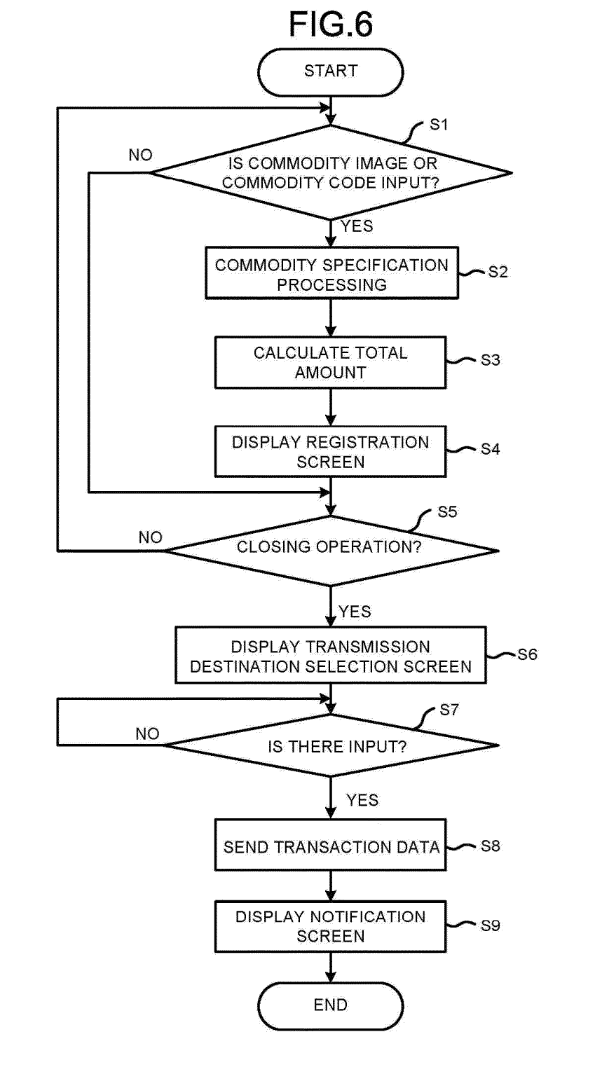

Next, operation of the checkout system 101 is described in detail. First, operation of the commodity data registration apparatus 102 is described. FIG. 6 is a flowchart illustrating commodity sales registration processing carried out by the commodity data registration apparatus 102.

As shown in FIG. 6, if it is determined that the commodity image or the commodity code obtained from the image captured by the image capturing section of the scanner 111 is input (YES in ACT S1), the control section 150 (information input module 152 or specification module 153) of the commodity data registration apparatus 102 executes commodity specification processing to retrieve the PLU file F1 based on the feature amount of the commodity image or the commodity code to specify the commodity (ACT S2).

The control section 150 (registration module 154 or calculation module 155) of the commodity data registration apparatus 102 reads the commodity information such as the commodity code, the commodity name, the unit price and the like of the specified commodity from the PLU file F1, and stores the read commodity information and the commodity quantity separately input through the touch panel 113 or the keyboard 115 in a work area of the RAM to register them. Then, the control section 150 adds up the purchased amounts based on the read unit price and the input commodity quantity to calculate a total amount and also stores the total amount in the work area of the RAM (ACT S3).

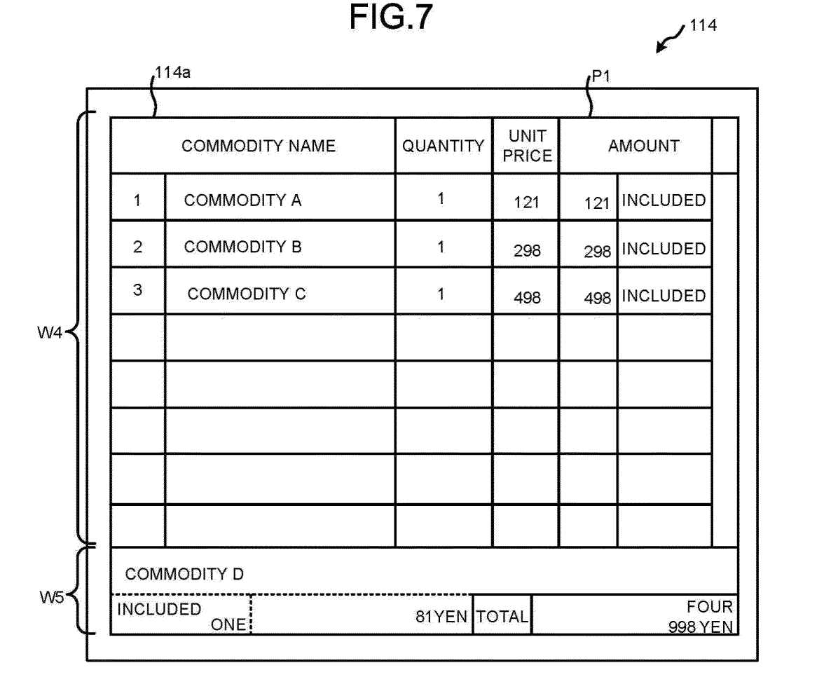

Sequentially, the control section 150 (registration module 154) displays a registration screen P1 (refer to FIG. 7) showing the read commodity information and the calculated total amount stored in the work area of the RAM on the display device 114 (ACT S4).

FIG. 7 is a front view illustrating an example of the registration screen P1. As shown in FIG. 7, the control section 150 controls the display device 114 to display the registration screen P1 in a display area 114a of the display device 114 while the commodity sales registration processing is executed. The registration screen P1 includes a window for registration W5 (hereinafter referred to as a registration window) and a window for showing registration completion W4 (hereinafter referred to as a registration completion window).

The commodity name, commodity unit price, individual commodity quantity and the like contained in the commodity information of the commodity specified through the commodity specification processing are displayed in the registration window W5. The commodity name, commodity unit price and the individual commodity quantity displayed in the registration window W5 are updated through the processing in ACT S1-ACT S3. The total amount and the total commodity quantity are also displayed in the registration window W5. The total amount and the total commodity quantity displayed are also updated through the processing in ACT S1-ACT S3.

The history displayed in the registration window W5 is displayed in the registration completion window W4. In a case in which the processing in ACT S1-ACT S3 is executed newly, the commodity name, commodity unit price, individual commodity quantity and the like displayed in the registration window W5 are displayed in the registration completion window W4.

The processing in ACT S1-ACT S4 described above is repeated until the closing operation (for example, the subtotal key (not shown) is touched or pressed) is carried out through the touch panel 113 or the keyboard 115 (NO in ACT S5).

If it is determined that there is an input by the closing operation from the touch panel 113 or the keyboard 115 (YES in ACT S5), the control section 150 (selection module 157) displays the transmission destination selection screen P2 (refer to FIG. 8) on the display device 114 to enable the operator to select one of the checkout apparatuses 103 to transmit the transaction data in one transaction (checkout data) to the selected destination (ACT S6).

FIG. 8 is a front view illustrating an example of the transmission destination selection screen P2. As shown in FIG. 8, the control section 150 controls the display device 114 to display, in the display area 114a of the display device 114, the transmission destination selection screen P2 in which a payment amount display window W3, a first transmission destination window W1 and a second transmission destination window W2 which are smaller than the payment amount display window W3 are defined in advance. The payment amount display window W3, arranged at the left end in the display area 114a, has a width more than half of that of the display area 114a and a height extending to nearly the upper end and the lower end of the display area 114a. The first transmission destination window W1 and the second transmission destination window W2 are arranged vertically adjacent to each other between the right side of the display area 114a and the right side of the payment amount display window W3 in FIG. 8.

The total amount and the total quantity of the commodity at the time of the input by the closing operation are displayed in the payment amount display window W3. In the payment amount display window W3, a button B1 for selecting a payment method, a button B2 for carrying out subtotal price-off and a button B3 for carrying out subtotal discount are arranged.

On the other hand, in the first transmission destination window W1 and the second transmission destination window W2, transmission receivable/unreceivable information indicating whether each checkout apparatus 103 serving as a transmission destination candidate is in a transmission receivable state or in a transmission unreceivable state as of the present time is displayed together with an identification number of each checkout apparatus 103. In addition, buttons B4 and B5 for declaring transmission are respectively arranged in the first transmission destination window W1 and the second transmission destination window W2. In a case in which the checkout processing is being executed in one of the checkout apparatuses 103, for example, the transmission unreceivable state is displayed in the one of the first and second transmission destination windows W1 or W2 (W1 in FIG. 8), but the buttons B4 and 55 for declaring transmission can be operated. This is because that, in general, the checkout processing in the checkout apparatus 103 is completed in short time and thus the display is changed to the transmission receivable state shortly even if the transmission unreceivable state is being displayed.

The method for selecting the checkout apparatus 103 as the transmission destination is not limited to the operation on the buttons B4 and B5. For example, the checkout apparatus 103 serving as the transmission destination may be selected through a combined operation on a numeric key and a sending key arranged on the keyboard 115. Specifically, the checkout apparatus 103 corresponding to the first transmission destination window W1 can be selected through the combined operation on a numeric key “1” and a sending key.

As stated above, the identification number of the checkout apparatus 103 serving as the transmission destination can be designated freely through a combination operation on the numeric key and the sending key arranged on the keyboard 115, in this way, the transaction data can also be transmitted to a checkout apparatus 103 other than the pre-designated checkout apparatus 103.

If it is determined that there is an input operation on the button B4 of the first transmission destination window W1 or the button B5 of the second transmission destination window W2 through the touch panel 113 (YES in ACT S7), the control section 150 (selection module 157, sending module 156 and communication control module 151) of the commodity data registration apparatus 102 sends a checkout data including the commodity information, the total quantity of each commodity, the total amount, and the total quantity of commodities stored in the work area of the RAM up to now to the selected checkout apparatus 103 as the transaction data of one transaction (ACT S8).

If the button B2 for carrying out subtotal price-off or the button B3 for carrying out subtotal discount of the payment amount display window W3 is operated prior to the operation on the button B4 of the first transmission destination window W1 or on the button B5 of the second transmission destination window W2, the balance obtained after the execution of the subtotal discount or the subtotal price-off on the total amount stored in the work area of the RAM is also sent to the selected checkout apparatus 103.

Further, the control section 150 may contain, in the transaction data of one transaction, identification data for specifying the transaction. The identification data is unique data for each transaction which can identify one transaction according to the total amount in one transaction, the unique number of the commodity data registration apparatus 102 that carries out the commodity sales registration processing of the one transaction, the date at the time the commodity sales registration processing of the one transaction is carried out, and the like.

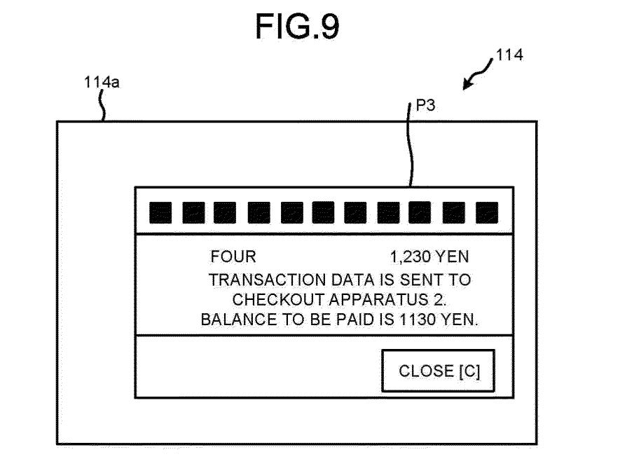

At last, the control section 150 (display control module 158) displays a notification screen P3 (refer to FIG. 9) for notifying that the transaction data (checkout data) is sent to the desired checkout apparatus 103 on the display device 114 (ACT S9), and then a series of commodity sales registration processing is terminated.

FIG. 9 is a front view illustrating an example of the notification screen P3. As shown in FIG. 9, the control section 150 displays the notification screen P3 indicating that the transaction data is sent to the desired checkout apparatus 103 on the display device 114. The total amount and the total quantity of the commodity are also displayed on the notification screen P3. Further, in a case in which the subtotal discount or the subtotal price-off is executed, the balance obtained after the execution of the subtotal discount or the subtotal price-off is also displayed.

The control section 150 displays the notification screen P3 on the display for operator 114 oriented to the operator; however, it is not limited to this. The notification screen P3 may be displayed on the display for customer 117 oriented to the customer. In this case, the customer may also be notified that the transaction data is sent to the checkout apparatus 103.

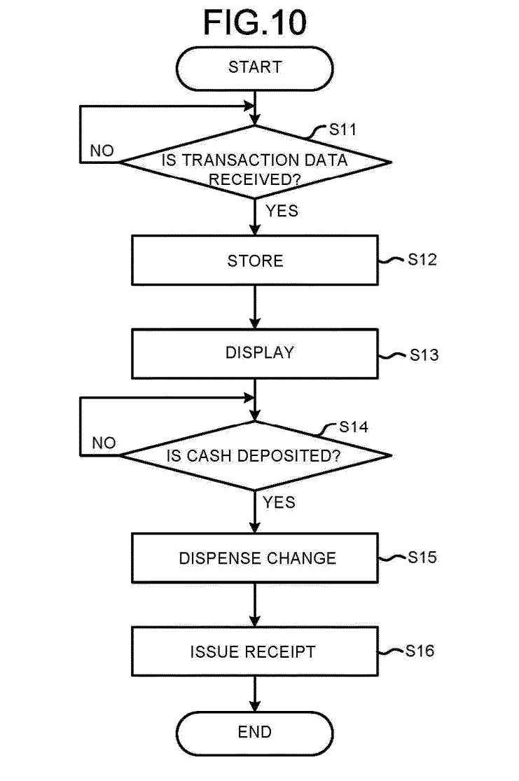

Next, the operation of the checkout apparatus 103 is described. FIG. 10 is a flowchart illustrating the checkout processing carried out by the checkout apparatus 103.

As shown in FIG. 10, when the control section 50 (communication control module 51) of the checkout apparatus 103 receives the transaction data (checkout data) from the commodity data registration apparatus 102 (YES in ACT S11), the received transaction data is stored in the work area of the RAM (ACT S12).

Next, the control section 50 (checkout module 52) displays the total amount (or the balance obtained by the execution of the subtotal discount or subtotal price-off) of one transaction contained in the received transaction data on the display device 61 of the display operation panel 6 (ACT S13).

Sequentially, the control section 50 (checkout module 52) receives the cash deposited through the cash depositing port 41 of the depositing/dispensing section 4 (ACT S14).

If the cash the amount of which is more than the total amount (or the balance obtained by the execution of the subtotal discount or the subtotal price-off) displayed on the display device 61 is deposited through the cash depositing port 41 of the depositing/dispensing section 4 (YES in ACT S14), the control section 50 (checkout module 52) calculates the difference in amount from the total amount (or the balance obtained by the execution of the subtotal discount or the subtotal price-off) and the payment or depositing amount to dispense the calculated difference through the bill dispensing port 42 and/or the coin dispensing section 43 as the change amount (ACT S15).

Then the control section 50 (checkout module 52) controls the receipt printer 9 to issue a receipt on which the received transaction data, the payment amount (deposit amount) and the change amount are printed from the receipt issuing port 91 (ACT S16), and then the checkout processing is terminated.

In this way, according to the checkout system 101 of the present embodiment, the checkout job can be eliminated from the entire jobs of the checker without increasing cost of receipt paper in the store or causing any inconvenience or trouble to the customer.

In the commodity data registration apparatus 102 according to the present embodiment, it is also possible, like a conventional apparatus, to temporarily store the transaction data in a store server and the like and then issue a receipt on which the identification data for identifying the temporarily stored transaction data is printed. In this case, a storage key is arranged in the display device 114 with the touch panel 113 or the keyboard 115, and the control section 150 of the commodity data registration apparatus 102 executes the storage of the transaction data if the storage key is operated. The customer receives a receipt on which the identification data for identifying the transaction data temporarily stored in the commodity data registration apparatus 102 is printed. Then the customer inputs the identification data printed on the receipt in the checkout apparatus 103 to read out the stored transaction data from the store server and the like to carry out the checkout processing.

In this way, even in a case in which an abnormality occurs in the network between the commodity data registration apparatus 102 and the checkout apparatus 103, the checkout job can be eliminated from the whole jobs of the checker (shop clerk).

Further, in the present embodiment, two checkout apparatuses 103 that can be selected as the transmission destination of the transaction data are arranged for one commodity data registration apparatus 102. However, the present invention is not limited to this. The checkout apparatus 103 that can be selected as the transmission destination and the number thereof can be set freely.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity data registration apparatus comprising:
a communication control module configured to control communication with a checkout apparatus connected through a network;
an information input module configured to input identification information for identifying various commodities;
a specification module configured to specify a commodity based on the identification information upon input of the identification information;
a registration module configured to register sales data of the specified commodity indicating the content of one transaction of the commodity;
a calculation module configured to calculate a total amount of the one transaction based on the registered sales data if the closing of the one transaction is declared; and
a sending module configured to send a checkout data including the registered sales data and the calculated total amount to the checkout apparatus through the communication control module.

2. The commodity data registration apparatus according to claim 1, further comprising a selection module configured to select one checkout apparatus in a case in which there is a plurality of checkout apparatuses connected through the network, wherein the sending module sends the registered sales data and the calculated total amount to the selected checkout apparatus.

3. The commodity data registration apparatus according to claim 2, wherein the selection module displays a selection screen for receiving the selection of checkout apparatus on a display device, and receives the selection of the one checkout apparatus in response to a selection operation on the selection screen.

4. The commodity data registration apparatus according to claim 1, further comprising a display control module configured to display information indicating the checkout apparatus selected as a transmission destination and the total amount on a display device at the time of the sending process by the sending module.

5. A checkout system comprising:
a commodity data registration apparatus according to claim 1; and
a checkout apparatus configured to execute checkout processing based on the sales data of the specified commodity indicating the content of the one transaction, and the total amount in the one transaction calculated based on the sales data, which are sent from the commodity data registration apparatus.

6. A method for executing transmission of a checkout data by a commodity data registration apparatus, including:
controlling communication with a checkout apparatus connected through a network;
inputting identification information for identifying various commodities;
specifying a commodity based on the identification information upon input of the identification information;
registering sales data of the specified commodity indicating the content of one transaction;
calculating a total amount of the one transaction based on the registered sales data if the closing of the one transaction is declared; and
sending the checkout data including the registered sales data and the calculated total amount to the checkout apparatus.
